(19) United States
(12) Patent Application Publication
(10) Pub. No.: US 2005/0206645 A1
(43) Pub. Date: Sep. 22, 2005

(54) Graphics processor with gamma translation

(76) Inventor: William R. Hancock, Phoenix, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/806,916

(22) Filed: Mar. 22, 2004

(51) Int. Cl. G06T 1/00; G06F 15/00

(52) U.S. Cl. 345/501

(57) ABSTRACT

A graphics processor is provided that includes a linear-output gamma translator, a processor core, and a non-linear gamma translator. The graphics processor facilitates improved performance by translating image data into a linear gamma space for processing and rendering, and then translating rendered image data into non-linear gamma space for output to the display. The graphics processor uses the translated linear gamma space image data during internal pixel operations, resulting in superior rendering performance. Furthermore, because image data is translated into linear gamma space in the graphics processor, image data from different sources having different gamma representations can be more efficiently and accurately merged. The rendered image data is then translated to a non-linear gamma space and is outputted to the display device. The graphics processor is thus able to accurately process graphics data in linear gamma space while still receiving and outputting data in perceptively desirable non-linear gamma spaces.

### FIELD OF THE INVENTION

This invention generally relates to displays, and more specifically applies to graphics processors for display systems.

### BACKGROUND OF THE INVENTION

Various types of optical displays are commonly used in a wide variety of applications. For example, computing devices such as personal computers, workstations, and personal digital assistants (PDA) and communication devices such as mobile phones and radios all use various types of displays. Displays are also commonly used for a variety of purposes on vehicles such as automobiles and aircraft. Optical displays can use a variety of different display mechanisms, such as LCD, CRT, projection and other devices. In many applications, the displays are driven by a specialized processor called a graphics processor, or sometimes referred to as a graphics processor unit (GPU). The graphics processor receives image data, generally in form of graphics primitives, and renders the primitives to create images on the graphics display.

One parameter associated with display systems is that of “gamma”. Gamma is a parameter that represents the intensity of light from a display as a function of the signal applied to the display. Specifically, the gamma of a display is the exponent of the power function that describes the relationship between the applied signal intensity and the intensity of the outputted light. For example, a conventional cathode ray tube typically produces light at an intensity equal to the applied voltage raised to a 2.5 power, and thus typically has a gamma of 2.5. A display system with a gamma of approximately 1.0 is said to have a linear gamma, meaning that changes in the display output follow a linear response.

People's perceptual response to visual image intensity is also non-linear. Specifically, a typical human eye has a response to intensity equivalent to a gamma of 0.45. Thus, an image source having an intensity of only 18% of a reference source will appear to the human eye to have a brightness of half the reference source. Stated another one, the human eye has more perceptive ability for dim luminance values than it does for bright luminance values.

Image intensity data is typically encoded using schemes that account for the gamma of the human eye. For example, to account for the perception of the human eye, some encoding schemes use a non-linear approach that results in more bandwidth (e.g., data bits) being allocated to relatively dim light intensities and less bandwidth allocated to relatively bright intensities. This means that the encoded signals have relatively greater resolution and smaller bit increment sizes at lower intensities where the human eye is more equipped to perceive differences in intensity. Image intensity data encoded using non-linear schemes are said to be in non-linear gamma space, while image intensity data encoded using a linear scheme is said to be in linear gamma space.

Current graphic processors are limited in that they typically treat the image intensity data as if it were encoded formatted in linear gamma space. Unfortunately, this is commonly not the case and the difference can result poor display performance, particularly during processing such as anti-aliasing and video merging. Furthermore, while some graphics processors may attempt to compensate for the non-linear gamma of the human eye by doing a correction on the output data, this solution is also limited in that it can result in a reduction of perceptual resolution.

Thus, what is needed is a graphics processor that provides improved performance by effectively compensating for difference gamma space encodings while providing good perceptual resolution.

### BRIEF SUMMARY OF THE INVENTION

The present invention provides a graphics processor that includes a linear-output gamma translator, a processor core, and a non-linear-output gamma translator. The graphics processor facilitates improved performance by translating image data into a linear gamma space for processing and rendering, and then translating rendered image data into non-linear gamma space for output to the display. The graphics processor uses the translated linear gamma space image data during internal pixel and texel operations such as anti-aliasing, resulting in superior rendering performance. Furthermore, because image data is translated into linear gamma space in the graphics processor, image data from different sources having different gamma representations can be more efficiently and accurately merged. The rendered image data is then translated to a non-linear gamma space and is outputted to the display device. The non-linear gamma space is preferably selected to closely resemble the perception of the human eye, resulting in improved perceptive display performance. The graphics processor is thus able to accurately process image data in linear gamma space while still receiving and outputting data in perceptively desirable non-linear gamma spaces.

In one embodiment, the linear-output gamma translator comprises an input gamma translator and the non-linear-output gamma translator comprises an output graphics translator. The input gamma translator translates image data inputted to the graphics processor into a linear gamma space. The output gamma translator translates the rendered image data into non-linear gamma space so it can be outputted to the display. Thus, the graphics processor performs rendering operations such as internal pixel and texel operates on the image data in the linear gamma space. Again, the linear representation of the image data facilitates efficient and accurate image merging. Furthermore, the output gamma translator translates the outputted image data to a non-linear gamma space that provides good perceptive display performance.

In another embodiment, the non-linear-output gamma translator comprises a memory write gamma translator and the linear-output gamma translator comprises a memory read gamma translator. In this embodiment, the graphics processor stores image data in memory in non-linear gamma space. Storing image data in the non-linear gamma space avoids the problem of losing fine resolution in dark colors that could otherwise occur. To facilitate storage in non-linear space, the graphics processor translates image data being written to memory into non-linear gamma space using the memory write gamma translator. Likewise, the graphics process translates image data read from memory back into the linear gamma space using the memory read gamma translator. Thus, the graphics processor is again able to process and render image data in the linear gamma space, while also having the ability to store and retrieve data in the non-linear space.

In another embodiment, the non-linear-output gamma translator and the linear-output gamma translator are internal to the graphics processor. In this embodiment, the graphics processor translates image data to a linear gamma space when certain graphics operations are to be performed. For example, the image data is translated to a linear gamma space when alpha blending logic, or anti-aliasing logic operations are to be performed on image data. Likewise, the results of the these graphics operations are translated into a non-linear gamma space, where further processing and outputting to the display device can occur in the non-linear gamma space. Thus, the graphics processor is again able to process and render image data in the linear gamma space, while also having the ability to output image data in the non-linear space.

In one variation on these embodiments the image data that is translated to linear gamma space, from either a image source or memory read, is up-converted to a higher resolution linear gamma space for processing and rendering. For example, incoming non-linear 8-bit image data can be translated into a 12 to 14 bit linear gamma space for processing and rendering, and then translating outgoing image data back into 8-bit non-linear gamma space for output to the display. The use of a higher resolution representation during processing provides the ability to fully maintain full perceptive resolution during processing. Furthermore, this provides the ability to store data in relatively low bit format without losing perceptive resolution, and is thus able to conserve memory space without excessively degrading the displayed image quality.

### BRIEF DESCRIPTION OF DRAWINGS

The preferred exemplary embodiment of the present invention will hereinafter be described in conjunction with the appended drawings, where like designations denote like elements, and:

FIG. 1 is a schematic view of a graphics processing system in accordance with an exemplary embodiment;

FIG. 2 is schematic view of a graphics processing system in accordance with a second exemplary embodiment;

FIG. 3 is schematic view of a graphics processor core in accordance with an exemplary embodiment; and

FIG. 4 is a schematic view of a graphics processing system in accordance with a third exemplary embodiment.

### DETAILED DESCRIPTION OF THE INVENTION

The present invention provides a graphics processor that facilitates improved performance by translating image data into a linear gamma space for processing and rendering, and then translating rendered image data into non-linear gamma space for output to the display.

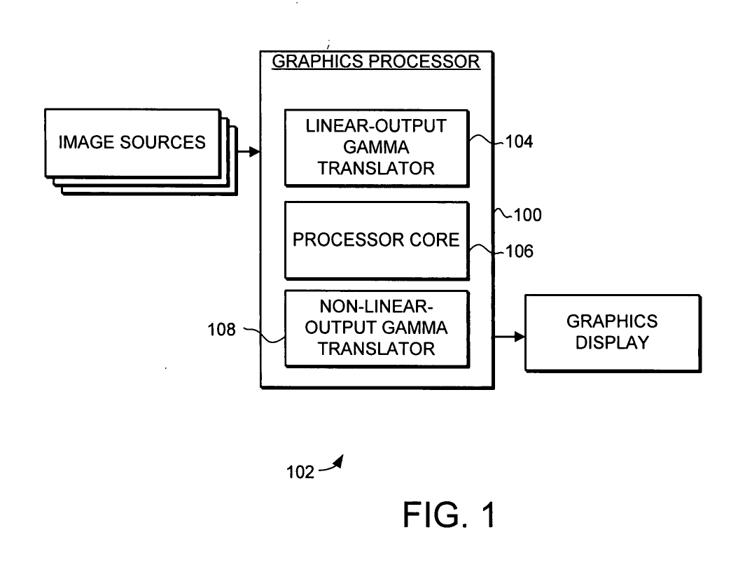

Turning now to FIG. 1, an exemplary graphics system 102 is illustrated schematically. The graphics system includes a graphics processor 100, the graphics processor including a linear-output gamma translator 104, a processor core 106, and a non-linear-output gamma translator 108. The graphics processor 100 receives image data from one or more image sources, renders the image data, and outputs the rendered image data to the graphics display. The linear-output gamma translator 104 translates the image data into a linear gamma space for rendering and processing. The processor core 106 can then use image data in the linear gamma space during rendering operations, resulting in superior rendering performance. For example, the processor core 106 can use the linear gamma space image data during internal pixel and texel operations such as anti-aliasing. Furthermore, because image data is translated into linear gamma space in the graphics processor, image data from different image sources that originally had different gamma representations can be more efficiently and accurately merged. The non-linear output gamma translator 108 is then used to translate the rendered image data into a non-linear gamma space. The rendered image data in the non-linear gamma space can then be outputted to the graphics display device. The non-linear gamma space is preferably selected to closely resemble the perception of the human eye, resulting in improved perceptive display performance. The graphics processor 100 is thus able accurately process image data in linear gamma space while still receiving and outputting data in perceptively desirable non-linear gamma spaces.

In one embodiment, the linear-output gamma translator 104 comprises an input gamma translator and the non-linear-output gamma translator 108 comprises an output graphics translator. The input gamma translator translates image data inputted to the graphics processor into a linear gamma space. The output gamma translator translates the rendered image data into non-linear gamma space so it can be outputted to the display. Thus, the graphics processor performs rendering operations such as internal pixel and texel operates on the image data in the linear gamma space. Again, the linear gamma space representation of the image data facilitates efficient and accurate image merging. Furthermore, the output gamma translator translates the outputted image data to a non-linear gamma space that provides good perceptive display performance.

In another embodiment, the non-linear-output gamma translator 108 comprises a memory write gamma translator and the linear-output gamma translator 104 comprises a memory read gamma translator. In this embodiment, the graphics processor stores image data in memory in non-linear gamma space. Storing image data in the non-linear gamma space avoids the problem of losing fine resolution in dark colors that could otherwise occur. To facilitate storage in non-linear space, the graphics processor translates image data being written to memory into non-linear gamma space using the memory write gamma translator. Likewise, the graphics process translates image data read from memory back into the linear gamma space using the memory read gamma translator. Thus, the graphics processor is again able to process and render image data in the linear gamma space, while also having the ability to store and retrieve data in the non-linear space.

In another embodiment, the non-linear-output gamma translator 108 and the linear-output gamma translator 104 are internal to the graphics processor. In this embodiment, the graphics processor translates image data to a linear gamma space when certain graphics operations are to be performed. For example, the image data is translated to a linear gamma space when alpha blending logic, anti-aliasing logic or video merge logic operations are to be performed on image data. Likewise, the results of the these graphics operations are translated into a non-linear gamma space, where further processing and outputting to the display device can occur in the non-linear gamma space. In this embodiment, other operations such as smooth shading can be performed on the image data in the non-linear gamma space, resulting in improved performance. Thus, the graphics processor is again able to process and render image data in the linear gamma space, while also having the ability to output image data in the non-linear space.

In one variation on these embodiments the image data that is translated to linear gamma space, from either any input or memory read, is up-converted to a higher resolution linear gamma space for processing and rendering. For example, incoming non-linear 8-bit image data can be translated into a 12 to 14 bit linear gamma space for processing and rendering, and then translating outgoing image data back into 8-bit non-linear gamma space for output to the display. The use of a higher resolution representation during processing provides the ability to fully maintain full perceptive resolution during processing. Furthermore, this provides the ability to store data in relatively low bit format without losing perceptive resolution, and is thus able to conserve memory space without excessively degrading the displayed image quality.

Image data can originate from a variety of sources. For example, image data can comprise video data from one or more cameras, such as video data from analog cameras that have been converted to digital data. Other sources of digital video data include synthetic generated video such as from a digitized data file, including MPEG encoded video (as found on DVDs), bit mapped files (such as photographs or charts) and even other computer graphics outputs (such as maps and other formats). As another example image data can comprise graphics command data generated by a computer system, such as OpenGL or DirectX drawing commands or terrain data bases (for a perspective view map) and other types of texture data. In all of these cases, the image data is processed by the graphics processor to render the image for display.

In general, gamma is a parameter associated with display systems that represents the intensity of light from a display as a function of the signal applied to the display. Specifically, the gamma of a display is the exponent of the power function that describes the relationship between the applied signal intensity and the intensity of the outputted light. For example, a conventional cathode ray tube typically produces light at an intensity equal to the applied voltage raised to a 2.5 power, and thus typically has a gamma of 2.5. A display system with a gamma of approximately 1.0 is said to have a linear gamma, meaning that changes in the display output follow a linear response. People's perceptual response to visual image intensity is also non-linear. Specifically, a typical human eye has a response to intensity equivalent to a gamma of 0.45. Thus, an image source having an intensity of only 18% of a reference source will appear to the human eye to have a brightness of half the reference source. Stated another one, the human eye has more perceptive ability for dim luminance values than it does for bright luminance values.

Image data is commonly encoded using different gamma representations. Image data encoded using non-linear schemes are said to be in non-linear gamma space or have a non-linear gamma representation. Likewise, image intensity data encoded using a linear scheme is said to be in linear gamma space or have a linear gamma representation. In all these cases, image data encoded using different gamma representations will have different relationships between the stored digital values and the intensity of light those values represent. For example, 50% brightness in linear space appears to be the same as 73% in a 0.45 gamma non-linear perceptual space. Likewise, 50% brightness in a 0.45 gamma non-linear perceptual space is only about 22% in a linear gamma space.

Image data is commonly encoded in non-linear gamma space to account for the perception of the human eye and the gamma of the display system being used to display image. Specifically, a non-linear gamma space is typically used that results in more bits being allocated at relatively low intensity levels, and less bits being allocated at relatively high intensity levels. As one example, image data is commonly encoded in a gamma space of approximately 0.45, allocating the more bits at relatively low intensity levels and thus tracking the perceptual gamma of the human eye. Because encoding image data in this manner tracks the behavior of the human eye, a non-linear gamma space representation of image data is able to have more perceptual resolution. Stated another way, the non-linear gamma space allocates more bits of data at lower intensities where the human eye is able to more accurately perceive changes in intensity. Likewise, the non-linear gamma space allocates less bits of data to higher intensities where the human eye is less able to perceive changes in intensity. This means that to the human eye, a non-linear gamma space representation of image data can have more perceptual resolution than a linear gamma space representation that uses the same overall number of bits.

It should also be noted that in accounting for human eye perception of intensity the non-linear gamma space should be corrected before being viewed by a human observer. Typically it is most desirable for the final image to look the same as if the viewer were looking through the original camera lens. When image data with a gamma of 0.45 is displayed on a monitor, which typically have a gamma of between 2.2 and 2.5, the result is the desired overall “linear gamma” for the system for the full video system. Stated another way, the gamma of typical monitors is almost the exact inverse of the human eye power function, is thus proper and appropriate for such video signals.

Conversely, most graphics data generated using languages such as Open GL and DirectX is expressed assuming a linear gamma representation in the rendering engine. Linear gamma coding is desirable to accurately simulate the physical world. However, many inputs tend to be actually expressed in perceptual gamma space, such as color coordinates even though the rendering process will treat the inputs as if they were in linear space. This mismatch results in arithmetic errors, which generally are ignored in prior systems.

Linear gamma coding is thus desirable to simulate the physical world whereas non-linear gamma based coding is desirable to match human perceptual needs. For example, in smooth shading the goal is for the ½ intensity element to appear to be half as bright as the full intensity element. However, in anti-aliasing, the desire is for two adjacent ½ intensity elements to appear in aggregate as bright as a single full intensity element. The former is a perceptual issue, the later is a physical issue in that the pixel pair needs to have as much energy as the single element.

In general, the goal of an imaging system is to be linear. In television systems, a typical CRT monitor has an inherent gamma of 2.5. By encoding the video at a gamma of 0.4, the overall system would be truly linear with the advantage that the intermediate video signal has a gamma that is close to the human eye's response curve (more sensitive in the critical dark areas.) The actual standard for television video specifies a gamma of 0.45 to compensate for the low contrast of a purely linear system in the dark environment of a home. Graphics image data, on the other hand, is inherently linear in nature. There is thus a mismatch in the desktop computer arena between the need to drive linear synthetic graphics and non-linear video at the same time, especially when the two have to be merged. Ideally, the gamma of the monitor would be selected to linear for graphics and to non-linear for video, but that is not practical. In contrast, the embodiments of this invention handle image data in the perceptually accurate gamma space and only reverts to linear gamma during internal processing steps in the GPU. This can also eliminate the “8-bit” bottleneck found in many conventional graphics processors.

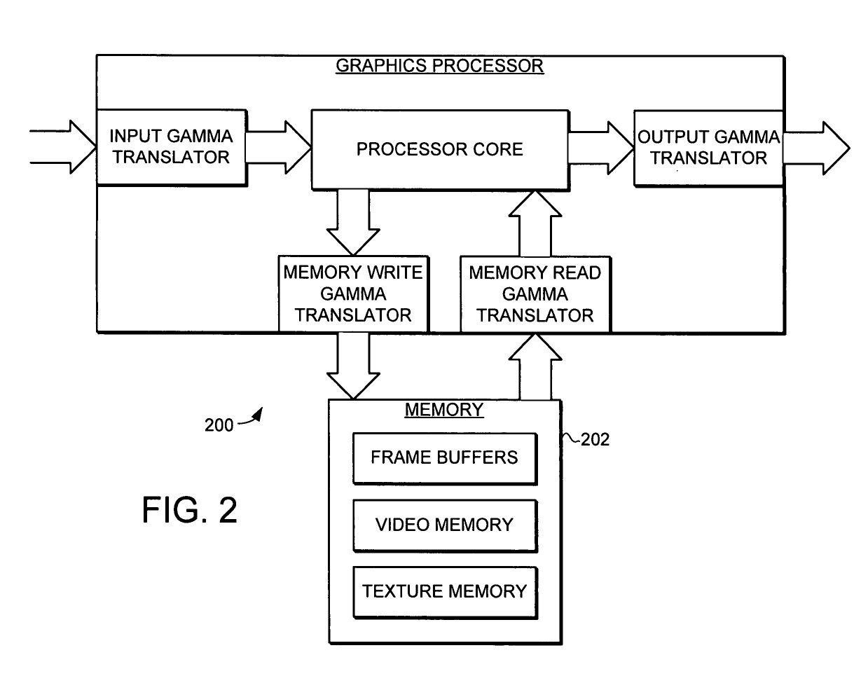

Turning now to FIG. 2, a first exemplary embodiment graphics processor 200 is illustrated. The graphics processor 200 includes a processor core, an input gamma translator, an output gamma translator, a memory write gamma translator, and a memory read gamma translator. The input gamma translator translates image data inputted to the graphics processor into a linear gamma space. The output gamma translator translates the rendered image data into non-linear gamma space so it can be outputted to the display. The memory write gamma translator translates image data being written to memory into a non-linear gamma space. The memory read gamma translator translates image data being read from the memory into a linear gamma space. The goal in these operations is for all image transmission and storage to be in the perceptually accurate gamma based space and all internal calculations to be in the physically correct linear space, but with high resolution to maintain perceptual accuracy.

In graphics processor 200 processing of the image data 200 is done in the linear gamma space. The resulting rendered output is outputted in a non-linear gamma space representation. Likewise, image data stored in the 202 is converted to a non-linear gamma space for storage, and converted to the linear space when read into the graphics processor 200.

The embodiment illustrated in graphics processor 200 provides several advantages. First, because processing of the image data in the graphics processor 200 is performed on image data in the linear gamma representation, the performance of certain rendering operations performed by the processor core can be improved.

As specific examples, using the linear gamma representation of image data during anti-aliasing results in improved performance. Anti-aliasing generally comprises the process of smoothing jagged edges in images by using intermediate shades of gray or color at shape edges. Anti-aliasing can be performed using a variety of techniques and procedures. In many of these techniques, performing the anti-aliasing on linear gamma space image data improves the quality of the anti-aliasing by reducing energy variations between subsampled elements.

As another example, using the linear gamma representation of image data during alpha blending results in improved performance. Alpha blending is in general a technique used to create semi-transparent features and represents a physical world calculation. Alpha blending generally comprises the mixing of transparency or opacity information into an image. Thus, alpha blending controls the simulation of opacity in an image. Alpha blending can be performed using a variety of different techniques and procedures. In many of these techniques, performing the alpha blending on linear gamma space image data improves the quality of the alpha blending because it is mathematically correct. For example, ½ of 1 should be 0.5 and ½ of 0.5 should be 0.25 and that is correct in linear space. In perceptual, non-linear gamma space of 0.45, ½ of 1.0 requires an answer of 0.73 (0.5 raised to the power of 0.45) not 0.5. As another perceptual space example, the value ½ is represented by 0.21 and ¼ of maximum is represented by 0.05, which is obviously not ½ of 0.21. Succinctly stated, ½ of Y^{X} is not equal to (½ Y)^{X} unless X=1, which corresponds to a linear gamma.

As another example, using the linear gamma representation of image data during video merging results in improved performance. Video merging is a general name for the techniques by which video image data from different sources are combined to create one image. For example, video from one camera can be combined with other graphics data to create images that are a combination of the video and graphics data. Video merging can be performed using a variety of techniques. A typical video merge mechanism is to use alpha blending of the symbology into the video. When done in linear gamma space, video merge with that mechanism thus exhibits the same mathematical correctness as any other form of alpha blending. Other forms of video merging, such as color keying, are not truly merge algorithms, but instead multiplex between the video and symbology. Those algorithms would not typically be affected by this system.

Thus, the performance of many types of rendering operations performed by the processor core is improved when the image data is in a linear gamma space representation.

One case where linear space is generally not appropriate is for smooth shading. There the goal is for the center of the smooth shaded line or polygon to be perceived as half way between the edges in brightness. Going from black to full brightness, than the center intensity should be perceived as ½ brightness (which would be 0.73 in linear space but is 0.5 in a perceptual non-linear gamma space). By treating the smooth shading outputs as if they already are in perceptual space, then that is exactly the effect desired.

The graphics processor 200 is also able to store image data in linear gamma space, and while also being able to retrieve and render data in a non-linear gamma space. Specifically, the memory write gamma translator translates image data being written to memory 202 into a non-linear gamma space. Likewise memory read gamma translator translates image data being read from the memory 2020 into a linear gamma space. As discussed above, operating on image data in a linear gamma space representation provides several advantages. Storing data in memory 202 in a non-linear gamma space also provides several potential advantages.

For example, storing image data in non-linear gamma space can conserve the use of memory space while providing good perceptual resolution. As discussed above, a non-linear gamma space can be implemented that allocates more bits for image data at relatively low intensity levels, and less bits for image data at relatively high intensity levels. Because this tracks the behavior of the human eye, a non-linear gamma space representation of image data is able to have more perceptual resolution than a linear gamma space representation that uses the same overall number of bits. Thus, storing the image data in a linear gamma space representation allows less bits to be used while still maintaining good perceptual resolution.

As illustrated in FIG. 2, the memory 202 includes frame buffers video memory and texture memory. The memory write gamma translator and memory read gamma translator can be used to gamma translate image data to and from each of these types of memories. Of course, these are just some examples of the type of memories that can be so used. Also, it should be noted that in other embodiments it may be desirable to translate image data to and from some memory types, and not translate image data to and form other memory types. For example, some digital cameras have the option of selecting linear or gamma based digital outputs. It would typically be best to select the non-linear gamma based output, but undesirable to convert the linear output. In other words, if possible, maintain each video source in its native non-linear gamma space.

The gamma translators can be implemented using a variety of different techniques and devices. One suitable technique is the formation of a lookup table. In a lookup table, incoming image data of one gamma representation is converted by looking up the intensity in the table and finding the corresponding intensity in the output gamma representation. As examples, lookup tables can either be in RAM or ROM depending on the level of flexibility desired. For example, the lookup table indexed by the value of ½ would yield either 0.21 (gamma to linear space) or 0.73 (linear to gamma space). Lookup tables can thus be used as any type of linear-output gamma translator that converts to a linear gamma space representation, or any type of non-linear output gamma translator that converts to a non-linear gamma space representation. A lookup table can be implemented to perform other functions in addition to gamma translation at the same time. As will be explained in greater detail below, the lookup table can also convert the image data to a higher or lower bit representation. Furthermore, the lookup table could also be used to perform brightness adjustments, contrast adjustments and other operations on the image data.

Of course, other techniques can also be used. A second exemplary technique is the use of a power function translation equation. Like the lookup table, a power function translation equation can be used to translate to a linear gamma space representation and to a non-linear gamma space representation, but is less flexible and typically requires more physical resources than does a look up table.

In addition to converting the data from a linear gamma space representation to a non-linear space representation and vice versa, it is also desirable in many applications to change to a higher or lower bit representation of the image data. As discussed above, image data stored in non-linear gamma space representation can be stored using less bits while still maintaining good perceptual resolution. Likewise, when image data is converted to a linear gamma space representation it needs to also be converted to a higher bit representation to maintain the same perceptual resolution. For example, if an 8-bit image data in a non-linear gamma space is converted to an 8-bit linear gamma space representation, then some of the data in the lower intensities will be lost. To compensate for this it is desirable in many applications to convert to a higher bit representation when converting to a linear gamma space representation. Likewise, it is desirable to in many applications to convert a lower bit representation when converting to a non-linear gamma space representation to reduce memory usage and transmission throughputs. For example, broadcast quality video generally requires 8 to 9 bits in perceptual space and 12 to 14 bits in linear space.

As one example of an implementation, the graphics processor 200 can be implemented to convert received image data to a higher bit representation when the image data is inputted to the graphics processor 200 and read from memory 202. Likewise, the graphics processor 200 can be implemented to convert the data to a lower bit representation when the image data is outputted from the graphics processor 200 and written to memory 202.

A more specific example receives image data in an 8-bit non-linear gamma space representation. The received image data is converted to a 12-14 bit linear gamma space representation. In this representation the image data is rendered by the graphics processor 202. The rendered image data is then converted to an 8-bit non-linear gamma space representation and outputted to the display. Likewise, image data is converted to an 8-bit non-linear gamma space representation when it is written to the memory 202, and is converted to a 12-14 bit representation when it is read from the memory 202. Of course, the 8, 12 and 14 bit values are just examples, and other systems may use different non-linear gamma space representations (e.g., 6, 10, 12) and different linear gamma space representations (e.g. 10, 18, 24).

Furthermore, instead of converting to a higher or lower bit representation, the image data can instead be converted to a floating point representation instead of integer, if that is the preferred processing mechanism in the GPU core.

Converting to a higher or lower bit representation can be accomplished using a variety of techniques. As one example, the conversion can be done using the same lookup table that is used to convert gamma space representation. As another example an actual power function calculator would be configured to output the desired number of bits.

There are some rendering functions that are preferably not preformed in a linear gamma space. For example, smooth shading is generally more effective when performed in a non-linear gamma space. In smooth shading the goal is to make the intensity vary smoothly from bright to dark at the perceptual level. In other words, the goal is to achieve shading that is perceptually smooth in perceived brightness rather than actual intensity. This can be accomplished by doing smooth shading interpolations in non-linear gamma space and then translating to linear gamma space for the additional rendering (e.g., alpha blending video merging and anti-aliasing).

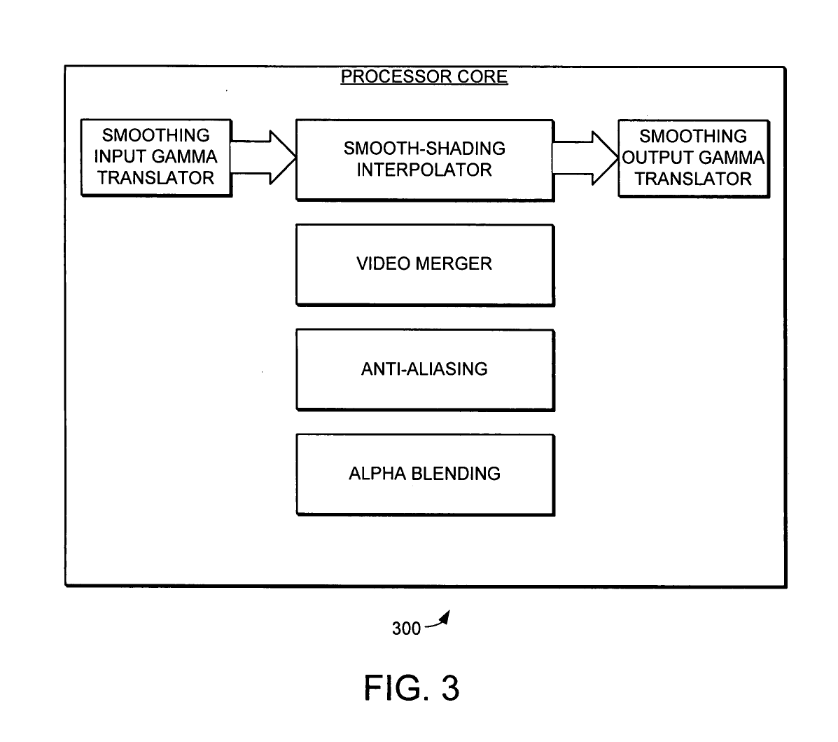

Turning now to FIG. 3, an exemplary processor core 300 is illustrated schematically. The exemplary processor core 300 includes functions for performing smooth shading, video merger, anti-aliasing and alpha blending. The processor core 300 also includes a smoothing input gamma translator and a smoothing output gamma translator. In this embodiment the smoothing input gamma translator translates image data to a non-linear gamma space for smooth shading. The smoothing output gamma translator translates the smoothed image data to linear gamma space for additional rendering, such as alpha blending video merging and anti-aliasing. Again, the gamma translation can be implemented with a variety of techniques and can also include a change in bit representation. This embodiment thus facilitates smooth shading in a non-linear perceptual gamma space while other rendering is performed in the desirable linear gamma space. This allows smooth shading to achieve shading that is perceptually smooth in perceived brightness.

It should be noted that while FIG. 3 illustrates the gamma translators as part of the processor core that this is just one example and that other implementations are possible.

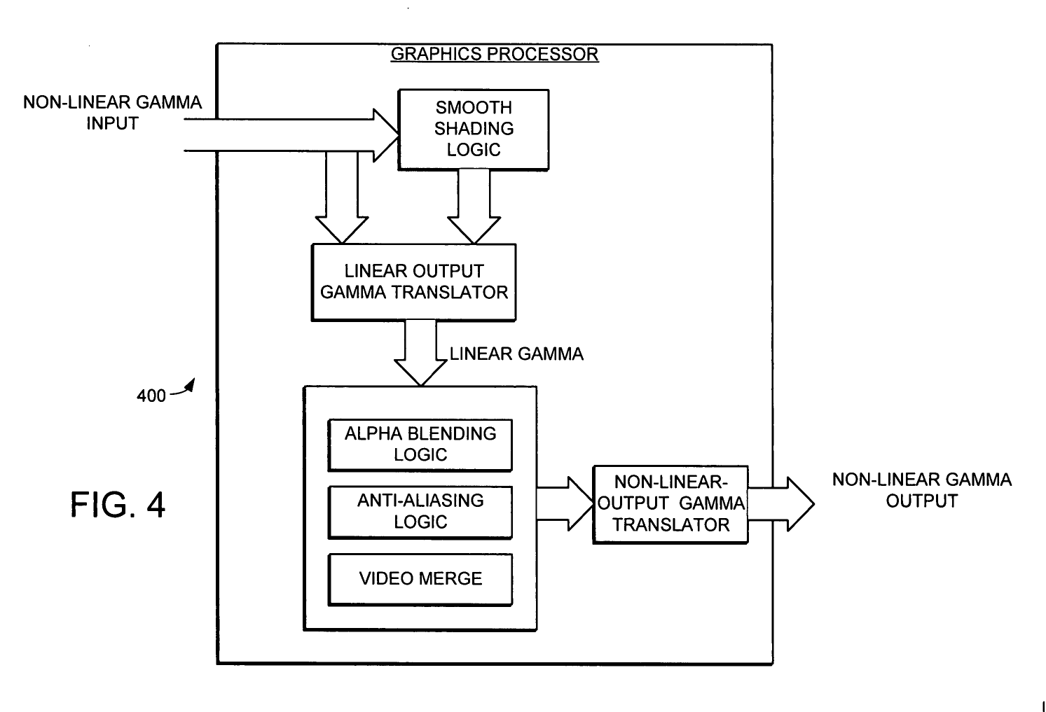

As another example, the optional smooth shading can be accomplished in non-linear gamma space by performing the gamma translation only after smooth shading has been accomplished. Turning now to FIG. 4, an exemplary graphics processor 400 is illustrated. The graphics processor 400 includes a smooth shading logic, alpha blending logic, anti-aliasing logic, video merging, a linear output gamma translator, and a non-linear output gamma translator. In this example, some received image data is smooth shaded in the original non-linear representation, while other image data goes directly to the linear output gamma translator. This allows smooth shading to occur in the more desirable non-linear representation, while image data that is not going to be smooth shaded (i.e., most video and flat shaded image data) is sent directly to the linear output gamma translator.

Specifically, in the illustrated example some received image data is smooth shaded in the original non-linear gamma space representation. The shaded image data is then gamma translated to a linear gamma space using the linear output gamma translator. Likewise, other image data that is not smooth shaded is passed directly to linear output gamma translator and translated to the linear gamma space. The remaining rendering can then be performed on the linear gamma representation of the image data. Specifically, alpha blending logic, anti-aliasing logic, video merging and other rendering can be performed on the image data in the linear gamma space representation. The rendered image data can then be converted back to a non-linear gamma space representation using the non-linear output gamma translator. The resulting rendered image data can then be outputted to the display system. This embodiment thus facilitates smooth shading in a non-linear perceptual gamma space while other rendering is performed in the desirable linear gamma space.

A graphics processor is thus provided that includes a linear-output gamma translator, a processor core, and a non-linear gamma translator. The graphics processor facilitates improved performance by translating image data into a linear gamma space for processing and rendering, and then translating rendered image data into non-linear gamma space for output to the memory or display. The graphics processor uses the translated linear gamma space image data during internal pixel operations, resulting in superior rendering performance. Furthermore, because image data is translated into linear gamma space in the graphics processor, image data from different sources having different gamma representations can be more efficiently and accurately merged. The rendered image data is then translated to a non-linear gamma space and is outputted to the display device. The graphics processor is thus able accurately process graphics data in linear gamma space while still receiving and outputting data in perceptively desirable non-linear gamma spaces.

The embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed. Many modifications and variations are possible in light of the above teaching without departing from the spirit of the forthcoming claims.

1. A graphics processor, the graphics processor receiving image data, the graphics processor comprising:
a linear-output gamma translator, the linear-output gamma translator translating the received image data into a substantially linear gamma space;
a processor core, the processor core rendering the translated image data to create rendered image data; and
a non-linear-output translator, the non-linear-output translator translating the rendered image data into a non-linear gamma space.

2. The graphics processor of claim 1 wherein the linear-output gamma translator comprises a lookup table.

3. The graphics processor of claim 1 wherein the linear-output gamma translator additionally converts the received image data into a higher bit representation.

4. The graphics processor of claim 3 wherein the higher bit representation comprises a floating point representation.

5. The graphics processor of claim 1 wherein the non-linear-output out put gamma translator additionally converts the rendered image data into a lower bit representation.

6. The graphics processor of claim 1 wherein the received image data includes graphics data and video data.

7. The graphics processor of claim 1 wherein the received image data is received from a memory.

8. The graphics processor of claim 1 wherein the linear-output gamma translator comprises an input translator, the input translator translating image data inputted into the graphics processor to a substantially linear gamma space.

9. The graphics processor of claim 1 wherein smooth shading of the image data is performed before the linear-output gamma translator translates the received image data into a substantially linear gamma space.

10. The graphics processor of claim 1 wherein the linear-output gamma translator comprises a memory read translator, the memory read translator translating image data read from a memory to a substantially linear gamma space, and wherein the non-linear-output gamma translator comprises a memory write gamma translator, the memory write gamma translator translating image data written to the memory to a non-linear gamma space.

11. The graphics processor of claim 1 wherein the non-linear gamma space representation comprises a gamma of approximately 0.45

12. The graphics processor of claim 1 wherein the processor core includes alpha blending logic, anti-aliasing logic and video merge logic, and wherein alpha blending, anti-aliasing and video merge are performed on the image data in the substantially linear gamma space.

13. The graphics processor of claim 1 wherein the linear-output gamma translator additionally converts the received image data into a higher bit representation, and wherein the non-linear-output gamma translator additionally converts the received graphics data into a lower bit representation, and wherein the higher bit representation comprises a 12-14 bit representation and wherein the lower bit representation comprises an 4-10 bit representation.

14. A method for rendering received image data in a graphics processor, the method comprising the steps of:
a) translating the received image data to a substantially linear gamma space;
a) rendering the translated image data to create rendered image data;
b) translating the rendered image data to a non-linear gamma space; and
d) outputting the non-linear gamma space rendered image data for display.

15. The method of claim 14 wherein the step of translating the received image data to a substantially linear gamma space comprises utilizing a lookup table.

16. The method of claim 14 wherein the step of translating the received image data to a substantially linear gamma space additionally converts the received image data into a higher bit representation.

17. The method of claim 14 wherein the step of translating the rendered image data to a non-linear gamma space additionally converts the received image data into a lower bit representation.

18. The method of claim 14 wherein the received image data includes graphics data and video data.

19. The method of claim 14 wherein the received image data is received from a memory.

20. The method of claim 14 further comprising the step of performing other rendering before the step of translating the received image data to a substantially linear gamma space.

21. The method of claim 20 wherein the other rendering comprises smooth shading.

22. The method of claim 14 wherein the step of translating the received image data to a substantially linear gamma space comprises translating image data received from a memory, and wherein the step of outputting the non-linear gamma space rendered image data for display comprises outputting to the memory.

23. A graphics processor, the graphics processor receiving image data, the graphics processor comprising:
an input gamma translator, the input gamma translator translating the received image data into a substantially linear gamma space and a higher bit representation;
a processor core, the processor core rendering the translated image data to create rendered image data; and
an output gamma translator, the output gamma translator translating the rendered image data into a non-linear gamma space output video data to a non-linear gamma space and a lower bit representation;
a memory write gamma translator, the memory write gamma translator translating image data written to a memory to a non-linear gamma space and a lower bit representation; and
a memory read gamma translator translating image data read from the memory to a substantially linear gamma space and a higher bit representation.

24. The graphics processor of claim 23 wherein input gamma translator and the output gamma translator comprise a lookup table.

25. The graphics processor of claim 23 wherein the higher bit representation comprises a 12-14 bit representation and wherein the lower bit representation comprises a 4-10 bit representation.

26. The graphics processor of claim 23 wherein the higher bit representation comprises a floating point representation.

27. The graphics processor of claim 23 wherein the received image data includes graphics data and video data.

28. The graphics processor of claim 23 wherein the processor core further includes a smooth shading function, and wherein the smooth shading function is performed on the image data before the input gamma translator translates the received image data into a substantially linear gamma space and a higher bit representation.
